(19) United States
(12) Patent Application Publication
(10) Pub. No.: US 2006/0147636 A1
(43) Pub. Date: Jul. 6, 2006

(54) Method and apparatus of forming a coating fluid pattern

(76) Inventors: Terrence E. Cooprider, Woodbury, MN (US); Laura M. Rider, Bronaugh, MO (US); Ronald W. Most, River Falls, WI (US)

Correspondence Address: 3M INNOVATIVE PROPERTIES COMPANY, PO BOX 33427, ST. PAUL, MN, 55133-3427, US

(21) Appl. No.: 11/027,511

(22) Filed: Dec. 30, 2004

(51) Int. Cl. B05D 3/12; B05C 3/00

(52) U.S. Cl. 427/355; 118/400

(57) ABSTRACT

A method of defining a pattern of coating fluid on a surface includes introducing coating fluid into a nip defined between a surface of a first roll and a surface of second roll. The roll surfaces are urged together at the nip under a nip pressure and move in opposite directions toward the coating fluid in the nip. The amount of coating fluid metered onto the second roll surface after the nip is a function the topography of the first roll surface and the nip pressure. The first roll surface is conformable and the first and second roll surfaces are urged together. Selected portions of the second roll surface are engaged with a doctor blade to remove coating fluid therefrom, wherein a pattern of coating fluid remains on the second roll surface which is defined by at least one stripe of coating fluid. The pattern of coating fluid is transferred from the second roll surface to a moving web by a reverse kiss coating.

### BACKGROUND OF THE INVENTION

This application relates to a method for applying a coating fluid. More particularly, the present invention relates to applying coating fluid in a specifically desired longitudinally disposed pattern.

In various product designs, it is desirable to coat one or more stripes of a coating material in a down-web or cross web pattern on a substrate such as a moving paper web or polymeric film web. In some applications, the coating material comprises a pressure sensitive adhesive (either permanent or removable). In particular, such adhesives may constitute pressure sensitive adhesive coatings including microsphere based adhesives, such as those disclosed in U.S. Pat. Nos. 6,296,932, 5,824,748, 5,756,625, 5,714,237, 5,571,617, 5,045,569, 4,495,318, 4,166,152, 3,857,731, and 3,691,140. It is important when processing such microsphere based adhesives that the relatively delicate microspheres themselves not be damaged or ruptured. For example, if the microspheres are cut or sheared, the adhesive materials therein could start to agglomerate, thereby making it difficult to handle the coating material and form a uniform layer thereof on a substrate. Such agglomeration also may cause the adhesive material to adhere to components of the coating equipment or further web processing equipment, thereby necessitating a shut down of the coating process while coating equipment and components are cleaned.

Accordingly, it is quite important that microsphere based adhesives be handled delicately in processing and that any shearing of those adhesives in fluid form be done in a manner that would minimize possible shearing of the microspheres themselves. This goal has proved problematic in many processing conditions where metering and further processing of a microsphere adhesive coating requires such activities as dispensing of the coating through a die under pressure, exposure of the coating to a doctor blade on a roller, or metering of the coating by passing it through a nip between opposed rollers. For instance, if there is insufficient space in a nip between opposed rolls for a microsphere to pass through that nip, it cannot do so. The microspheres are then squeezed out to the sides of the roll and do not accumulate on any coating being deposited after the nip The deficiencies in prior art processes include inadequate transfer of adhesive from an etched gravure application roll to the web, or undue splitting of the coating material in film form during flexographic coating. In addition, the shear sensitivity and/or poor rheological properties of the microsphere adhesive fluid may result in excessive coagulation (i.e., caused by agglomeration of sheared adhesive microspheres) and/or non-uniform coating lay down, which will result in non-uniform streaks of adhesive, mottled adhesive patterns, coating voids or an undesired “orange peel” coating which affect the adhesion level of the dried coating.

### BRIEF SUMMARY OF THE INVENTION

The present invention includes an apparatus and a method of defining a pattern of coating fluid on a surface which comprises introducing coating fluid into a nip defined between a surface of a first roll and a surface of a second roll. The roll surfaces are urged together at the nip under a nip pressure and move in opposite directions towards the coating fluid in the nip. The amount of coating fluid metered onto the second roll surface after the nip is a function of the topography of the first roll surface and the nip pressure. The method further comprises engaging selected portions of the second roll surface with a doctor blade to remove coating fluid therefrom, wherein a pattern of coating fluid remains on the second roll surface which is defined by at least one stripe of coating fluid.

The above summary of the present invention is not intended to describe each disclosed embodiment or every implementation of the present invention. The figures and the detailed description which follow more particularly exemplify illustrative embodiments.

### BRIEF DESCRIPTION OF THE DRAWINGS

The present invention will be further explained with reference to the drawing figures listed below, where like structure is referenced by like numerals throughout the several views.

FIG. 1 is a perspective view of a web coating apparatus of the present invention having a grooved fountain roller and a striped doctor blade.

FIG. 2 is a schematic side view of the inventive coating apparatus of the present invention, further illustrating a coating fluid recycling and consistency management system.

FIG. 3 is a schematic sectional view as taken along lines 3-3 in FIG. 2, showing a striped doctor blade.

FIG. 3A is an enlarged sectional view of a helically grooved surface of a fountain roll adapted for use in the coating system of the present invention.

FIG. 4A illustrates a plan view of a second alternative edge configuration for a striped doctor blade adapted for use in the present invention.

FIG. 4B illustrates a plan view of a third alternative edge configuration for a striped doctor blade adapted for use in the present invention.

FIG. 5 is a schematic side view of the coating apparatus of FIG. 2, showing an impression roll moved to a position wherein a moving web is not in contact with a coating fluid applicator roll.

FIG. 6 is a schematic illustration of the inventive coating apparatus of the present invention on a web printing line.

FIG. 7 is a perspective view of an alternative embodiment of a web coating apparatus and method of the present invention, wherein the impression roll has a raised image pattern formed to intermittently bring a moving web into contact with an applicator roll.

FIG. 8 is a schematic side view of the coating apparatus of FIG. 7, wherein an impression roll is rotated to a position wherein the moving web contacts the applicator roll.

FIG. 9 is a schematic side view of the coating apparatus of FIG. 7, wherein the impression roll is rotated to a position wherein the moving web is spaced from the applicator roll.

FIG. 10 is a schematic sectional view-as taken along lines 10-10 in FIG. 8.

FIG. 11 is a schematic side view of a third alternative embodiment of the web coating apparatus and method of the present invention.

While the above identified figures set forth several embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION

Applicants have discovered and developed a unique apparatus and process for selectively applying a down-web pattern of coating fluid onto a moving web. This pattern, in its simplest form, may comprise a single stripe of coating fluid deposited on the moving web or a plurality of parallel stripes applied along the length of the moving web. In addition, the pattern can be continuously applied to the moving web (i.e., a continuous stripe or plurality of stripes of coating fluid), or the application of the pattern can be stopped all together even though the web continues to move past the inventive coating apparatus. In addition, the apparatus can be configured to apply an intermittent pattern of coating fluid to the web (i.e., a discontinuous strip of coating fluid applied along the length of the moving web, such as “dashes” or blocks of coating fluid).

Alternative methods and apparatus for achieving these ends are disclosed herein. In each instance, the coating fluid is handled in a manner which does not create excessive shear forces acting upon the coating fluid that would otherwise damage components of the coating fluid (e.g., microspheres of adhesive material) and lead to non-uniform applications thereof.

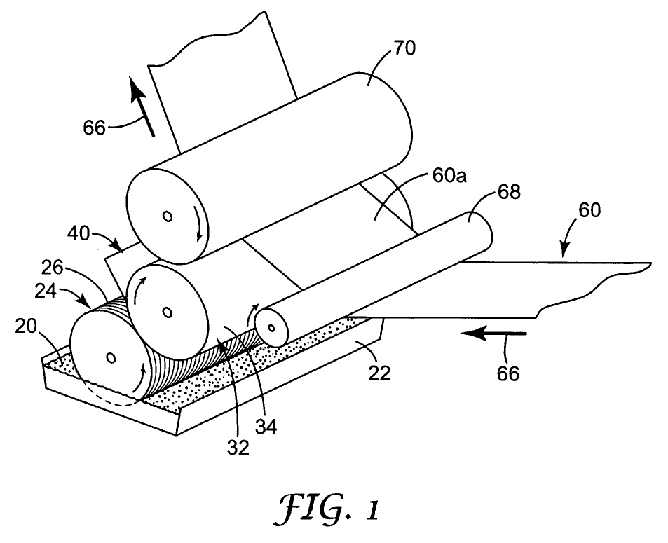

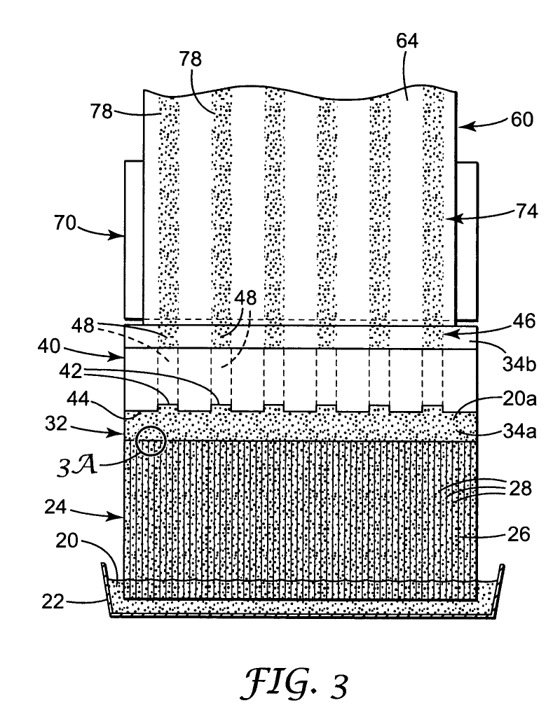

FIGS. 1, 2 and 3 illustrate schematically an apparatus and process for defining a coating fluid pattern and selectively applying that pattern to a moving web. Coating fluid 20 is supplied from a pan 22 or other suitable supply means (such as an enclosed doctor blade system) 25 to a rotating fountain roll 24. The fountain roll 24 has a surface 26 defined by a helical groove 28 (See FIG. 3A) extending along a longitudinal circumference of the fountain roll 24 (i.e., extending perpendicular to an axis of the fountain roll 24).

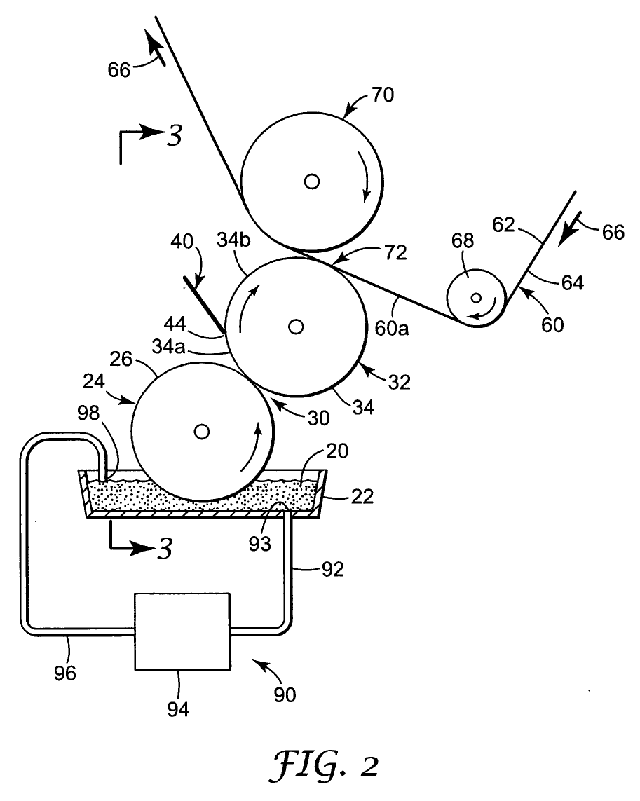

The coating fluid 20 is picked up by the moving fountain roll surface 26 and carried into a nip 30 (see FIG. 2) defined between the fountain roll 24 and an axially parallel rotating applicator roll 32. The applicator roll 32 has a smooth circumferential surface 34 which contacts the fountain roll surface 26 at the nip 30 and which transfers (from the groove 28) coating fluid 20 from the fountain roll surface 26. The fountain roll 24 and applicator roll 32 are rotated so that their respective surfaces 26 and 34 move toward the nip 30. The amount of coating fluid which is metered onto the applicator roll surface 34 after the nip 30 (indicated as post-nip applicator roll surface 34a in FIG. 2) is a function of the topography of the fountain roll surface 26 and the pressure at the nip 30. As noted above, the topography of the fountain roll surface 26 in one instance comprises a helical groove 28.

In FIG. 3, a layer of metered coating fluid 20a is borne on the post-nip applicator roll surface 34a and is uniformly disposed across the entire operative area of that surface 34a. Also in FIG. 3, the entire fountain roll surface 26 is illustrated as comprising the desired coating fluid transfer topography (e.g., the helical groove 28); however, less then the entire surface may have the desired topography for coating fluid metering and transfer.

A doctor blade 40 engages the post-nip applicator roll surface 34a, as seen in FIGS. 2 and 3. The doctor blade 40 is a reverse doctor blade having one or more notches 42 cut out from its operative scraping edge 44 so that the edge 44 does not engage or doctor the metered coating fluid 20a from all portions of the applicator roll surface 34a. The pattern of notches 42 on the edge 44 of the doctor blade 40 thus defines a pattern 46 of coating fluid 20a remaining on the applicator roll 32, and specifically on a post-doctor blade applicator roll surface 34b. As illustrated in FIG. 3, each notch 42 allows a stripe 48 of metered coating fluid 20a to remain on the surface of the applicator roll 32 as its surface moves beyond the doctor blade 40. Side edges of each stripe 48 remain quite distinct and linear, and the coating fluid within the stripe 48 remains uniform in its coating weight from side to side and along the length of the stripe (in FIG. 3, the side edges of each stripe 48 are shown in phantom behind the doctor blade 40).

In FIG. 2, a web 60 (such as a paper sheeting or polymeric sheeting) having a top surface 62 and an opposed coating surface 64 is moved past the applicator roll 32, in direction of arrows 66. The web 60 is moved in an opposite direction from the direction of movement of the applicator roll surface 32. The path that the web 60 traverses adjacent to the applicator roll 32 is defined in part by an idler roll 68 and an impression roll 70. As seen in FIG. 2, the web 60 contacts the applicator roll 32 along in a free span 60a without any support on the top surface 62 of the web 60 opposite a line of contact between the surface of the applicator roll 32 and the web 60. At this line of contact (indicated as at 72 in FIG. 2) the coating fluid pattern 46 on the post-doctor blade applicator roll surface 34b is transferred onto the coating surface 64 of the web 60 in a corresponding pattern 74 of coating fluid (see FIG. 3). The pattern 74 on the web 60 includes a stripe of coating fluid 78 corresponding to each stripe 48 borne on the applicator roll 32. Each stripe 78 has generally linear side edges and a uniform coat weight, from side to side and along the length of the stripe 78. The coated web 60 is then advanced to a drying or curing station for the coating fluid thereon, and then to further processing or converting stations along its web path. The contact between the web and the applicator roll surface is thus defined as a reverse kiss for purposes of coating fluid transfer.

In one embodiment, the line of contact 72 may constitute a line having a width (as measured in direction of web travel) of about 0.125 inch to about 0.25 inch. As seen in FIG. 2, there is a short span of web 60 between the line of contact 72 (the reverse kiss contact between the applicator roll surface 34 and the coating surface 64 of the web 60) and the line of contact of the top surface 62 of the web 60 with the impression roll 70. This reverse kiss coating arrangement is disclosed in EP 0847308. As opposed to a larger span distance, this short span assures greater web stability during the transfer of the coating fluid to the web, which in turn yields improved down-web and cross-web uniformity of coating fluid transfer and application characteristics such as coat weight.

In addition, one means for establishing a desired coating weight for the coating fluid transferred onto the web 60 is by having the web 60 traverse the applicator roll line of contact 72 at a speed different then the speed of the applicator roll surface 34. In one embodiment, the applicator roll surface 34 moves at a speed 40% faster than the coating surface 64 of the web 60. Running the applicator roll 32 at such an overspeed relation results in a thicker coating of coating fluid being placed on the coating surface 64 of the web 60 than was borne on the post-doctor blade applicator roll surface 34b (yet the stripes 78 of coating fluid on the web 60 still maintain reasonably sharp linear side edges). The fountain roll surface 26 is advanced at about the same surface speed as the applicator roll surface 34. Thus, both surfaces of the fountain roll and applicator roll can move at about the same speed relative to one another through the nip 30. In an alternative embodiment, the fountain roll surface may be moved at a slower speed than the applicator roll surface speed, as a means of reducing foaming effects in the coating fluid.

In the fluid coating system illustrated in FIGS. 1-3A and described above, initial metering of the coating fluid for coating purposes is a function of the topography of the fountain roll surface 26 and the nip pressure between the fountain and applicator roll surfaces. Metered coating fluid 20a on the applicator roll 32 is then shaped into a desired pattern by the form of the doctor blade 40. This pattern is then transferred from the applicator roll 32 in a reverse kiss coating operation onto the coating surface 64 of the web 60 as pattern 74 of coating fluid.

A coating fluid particularly adapted for use in connection with the inventive coating system is a microsphere based adhesive. Such an adhesive may have microspheres having an average diameter ranging from about 5 microns to about 200 microns. An adhesive having microspheres having an average diameter of about 40 microns is typical. Microsphere based adhesives for which the inventive coating system is believed applicable include those disclosed in U.S. Pat. Nos. 6,296,932 and 5,571,617. In these adhesive materials, adhesive microspheres are suspended in a aqueous solution which may include other additives to achieve desired fluid or adhesive characteristics. As illustrated in FIG. 3A, the helical groove 28 formed in the fountain roll surface 26 of the fountain roll 24 is sized to at least partially accept one or more microspheres 80 therein. The groove 28 shown in FIG. 3A is a V-shaped groove, but other groove shapes will suffice (e.g., a U-shaped groove), so long as the groove is deep enough to accept one or more microspheres therein. The groove may have a depth of about 50 microns to about 300 microns, and, for a V-shaped groove, a tooth angle of about 15 degrees to about 120 degrees (or in some embodiments a tooth angle of about 60 degrees to about 90 degrees may be preferred). The groove may be disposed at about 40 grooves per inch to about 300 grooves per 25 inch, as measured longitudinally (in an axial dimension) across the fountain roll surface 26 (in some embodiments, about 60 grooves per inch to about 150 grooves per inch may be preferred).

As seen in FIG. 3A, a land 82 is provided between adjacent portions of each helical groove 28. In one embodiment, the helical groove 28 has a depth of 100 microns, with an opening width of 205 microns, and the land 80 has a width of 113 microns between adjacent portions of the helical groove 28. The helical groove 28 is aligned at an angle of about 80 degrees to about 90 degrees relative to an axis of the fountain roll 24. In one embodiment, the helical groove is aligned at nearly 90 degrees relative to that axis (e.g., 89.95 degrees).

The fountain roll surface may have an alternative surface topography (other than a helical groove), so long as the surface topography includes surface features deep enough to permit passage of one or more microspheres therein through the nip between the rotating fountain and applicator rolls without damaging the microspheres. For example, the surface topography may comprise a plurality of annular, parallel grooves on the fountain roll surface to serve the metering function. Likewise, the surface topography may comprise a plurality of cells (e.g., in a screen pattern) on the fountain roll surface for establishing the metering function of the microsphere adhesive coating fluid.

The fountain roll surface is formed of a conformable material such as rubber. Other exemplary materials suitable for forming the fountain roll surface include urethane rubber, neoprene and ethylene propylene diene monomor (EPDM) rubber. The surface of the fountain roll may have a durometer ranging from about 40 to about 90. The applicator roll surface is hard (i.e., non-conformable) and smooth, and in one embodiment is a chrome plated roll surface of a steel roll. Other exemplary suitable materials for the applicator roll surface include stainless steel, hard plastics and polished ceramics. The surfaces 26 and 34 of the fountain roll 24 and the applicator roll 32, respectively, contact each other at the nip 30. The rolls are urged together by a nip pressure at the nip 30, so that the smooth applicator roll surface 34 is pushed against the lands 82 of the fountain roll surface 26. Although the nip pressure may cause some deformation, the surface features in the topography of the fountain roll 24 (e.g., grooves 28) maintain their depth sufficient to permit passage of one or more microspheres 80 therein through the nip 30.

This relationship thus defines a specific means for metering the number of microspheres 80 which are able to pass through the nip 30 and are then deposited on the applicator roll surface 34a. In addition, the microspheres 80 passing through the nip 30 via the surface topography are not damaged or sheared as they pass through (although some microsphere compression may occur).

The grooves (or other suitable topography features) allow the microspheres to essentially “line up” for passage through the nip, and because of the relative size of the grooves and microspheres, only so many microspheres may pass through over time as the rolls rotate past the nip. Through this arrangement, precise metering of the amount of microspheres placed on the smooth applicator roll surface is thus obtained, which then further leads to a uniform deposition of adhesive on the web 60 once the adhesive is transferred from the applicator roll 32 to the web 60. An increase in the nip pressure can cause the fountain roll surface to deform and thus cause the grooves to become smaller in cross-section. This would, in turn, reduce the number and rate of microspheres allowed through the grooves. Likewise, a decrease in pressure will allow more microspheres to pass. Thus, the amount of coating fluid containing microspheres which is allowed to pass through the nip is a function of the nip pressure applied between the fountain and applicator rolls.

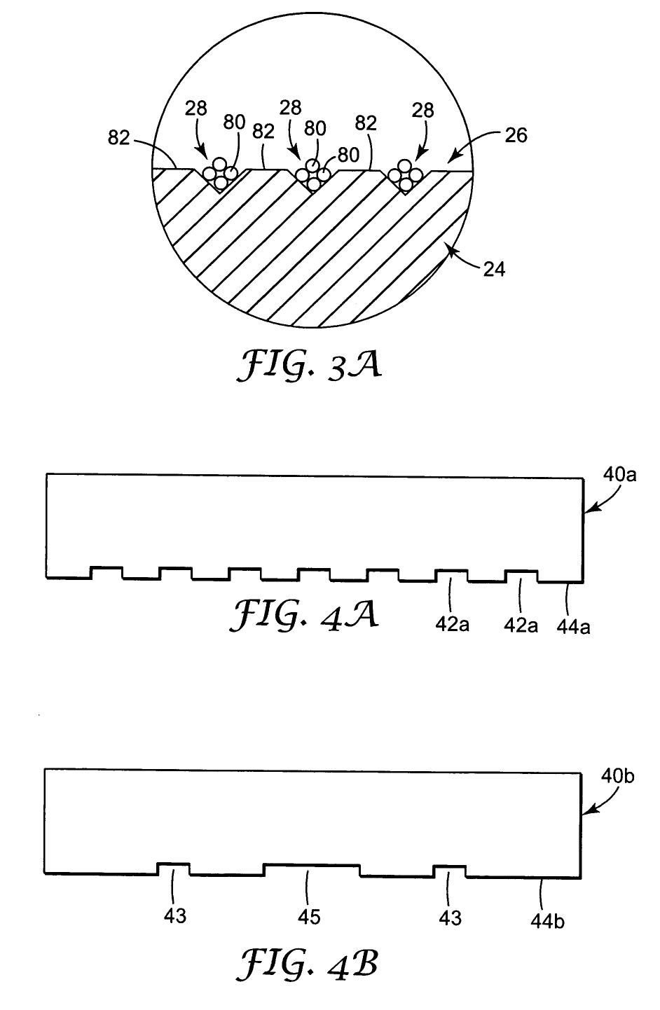

As explained above, the pattern 46 of coating fluid applied onto on the post-doctor blade applicator roll surface 34b is defined entirely by the formation of the notches 42 along in the operative edge 44 of the doctor blade 40. In FIG. 3, six notches 42 of equal size are illustrated, which thereby define six equally wide stripes 48 of coating fluid on the post-doctor blade applicator roll surface 34b. Those portions of the post-doctor blade applicator roll surface 34b bearing no coating fluid have been scraped clean of coating fluid by the unnotched portions of the operative edge 44 of the doctor blade 40. Those unnotched portions scrape the coating fluid 20a off the applicator roll surface 34 and the coating fluid thus runs back onto the fountain roll surface 26 and then is carried back into the pan 22. The coating fluid pattern 46 can be easily modified by replacing the doctor blade 40 with an alternative doctor blade having a different alignment of notches thereon. FIGS. 4A and 4B illustrate alternative doctor blade configurations. Doctor blade 40a in FIG. 4A has seven equally sized notches 42a along its operative scraping edge 44a, and thus will define seven stripes of coating fluid on the applicator roll surface (and ultimately on the moving web). Doctor blade 40b in FIG. 4B has three notches, two equally sized notches 43 and one larger notch 45, along its operative scraping edge 44b. Accordingly, doctor blade 40b will define three stripes of coating fluid on the applicator roll surface with one of those stripes (a central stripe, as illustrated) being wider then the other two stripes (which are equal width). As can be appreciated, any desired pattern of notches can be formed on the doctor blade, which will accordingly define a desired pattern of coating fluid on the applicator roll surface (and ultimately on the web). What is constant among all doctor blade variations is that one or more notches in the operative edge of the blade are provided to define one or more stripes of coating fluid on the applicator roll surface. The non-notched portions of the operative edge of the doctor blade scrape coating fluid off the applicator roll surface and thus define areas where no coating fluid is transferred to the web.

The doctor blade (or at least its operative edge) is formed from a stiff material which is aligned to scrape against the hard and smooth applicator roll surface 34. Such exemplary materials include stainless steel, polyester, ceramic coated materials and composite materials. The doctor blade may comprise one continuous blade extending across the surface of the applicator roll (such as illustrated in FIG. 3), or it may be formed from a plurality of discrete blade pieces aligned across the surface of the applicator roll to define a desired-notch pattern.

FIG. 2 includes a schematic illustration of a recycling and replenishment system 90 for the coating fluid 20. A drain conduit 92 extends from an opening 93 in the pan 22 to a replenishment tank assembly 94. The tank assembly 94 has means for receiving additional coating fluid to replenish the coating fluid which has been applied by the coating fluid application system to the web 60. The tank assembly 94 includes a pump for pumping coating fluid 20 through an inlet conduit 96 to an outlet 98 for delivering coating fluid 20 back to the pan 22. The tank assembly 94 may also include means for monitoring the viscosity of the coating fluid 20. When the coating fluid 20 comprises microspheres borne in an aqueous solution, a “dewatering” naturally occurs in part because of evaporation of the aqueous solution, but also because the metering achieved by the grooves in the nip 30 allows a lower percentage of solids (i.e., microspheres) to be transferred from the fountain roll to the applicator roll than an unmetered transfer would allow, thus elevating the solidity (and viscosity) of the adhesive being scraped off the applicator roll and returned to the pan for reuse. Also, the coating fluid scraped off the applicator roll leaves a thin film of water (i.e., aqueous solution) on the surface of the applicator roll, thus dewatering the coating fluid. The viscosity of the adhesive being delivered to the pan 22 is monitored, and if necessary because of dewatering, additional aqueous solution is added to maintain a desired viscosity level. In one embodiment, the viscosity monitoring and adjustment function is handled by an Inkspec Junior viscosity control system, available from Peripheral Advanced Design, Inc., Boucherville, Quebec, Canada. While only shown with respect to FIG. 2, it is understood that a coating fluid recycling and replenishment system 90 to perform the functions described above may be provided for any embodiment of the inventive coating application system.

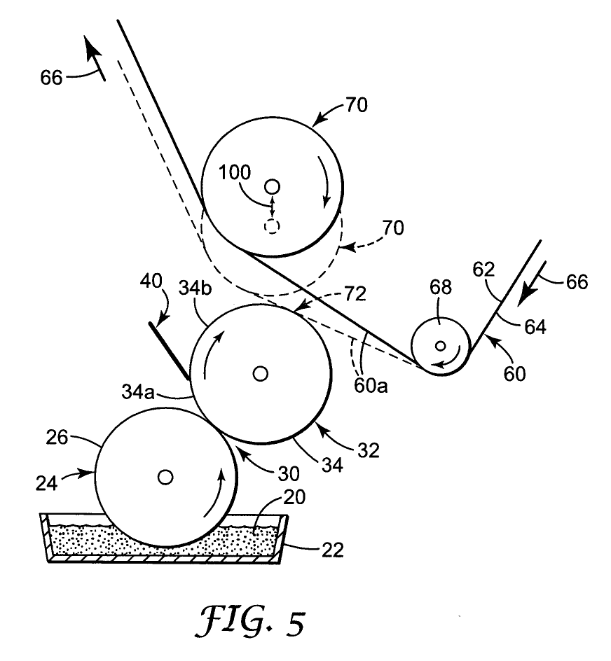

As noted above, the coating surface 64 of the web 60 picks up the coating fluid along the line of contact 72 with the post-doctor blade applicator roll surface 34b. With the inventive coating system, however, it is quite easy to turn the process “off” with respect to the moving web 60 by simply disengaging the coating surface 64 of the web 60 with the applicator roll surface 34. This is accomplished, in one embodiment, by moving the rotating impression roll 70 away from the applicator roll 32. FIG. 5 illustrates (in solid lines) the applicator roll 70 moved a sufficient distance away from the applicator roll 32 to separate the web 60 from the applicator roll surface 34. The free span 60a of the moving web 60 thus follows a path that does not engage the applicator roll surface 34 at any line of contact, thereby not enabling a transfer of coating fluid from the applicator roll 32 to the web 60. When in this separated configuration, the stripes 48 of coating fluid on the applicator roll surface 34 stay on the applicator roll surface 34 and reenter the nip 30 as the applicator roll 32 rotates (and are again subjected to the metering effects of the opposed smooth and textured surfaces of the applicator and fountain rolls, respectively). When it is desired to turn the coating process “on” the impression roll 70 is moved toward the applicator roll 32 (as shown in phantom in FIG. 5) until the free span 60a again contacts the post-doctor blade applicator roll surface 34b at the line of contact 72, thereby initiating the transfer of coating fluid by a reverse kiss transfer onto the coating surface 64 of the web 60 in the desired coating fluid pattern 74. As illustrated in FIG. 5, movement of the impression roll 70 in direction of arrows 100 is effective to turn “off” and “on” the coating process relative to the web 60.

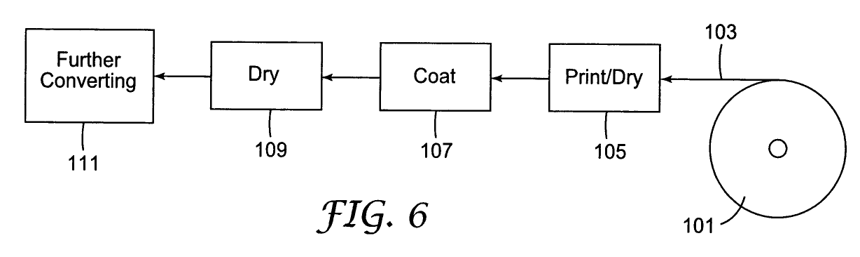

The above described simple means for activating and deactivating the application of coating fluid to a moving web makes the present inventive system readily compatible with an established printing process line for a moving web. FIG. 6 schematically illustrates a web printing line which includes the inventive coating process. A web supply 101 provides a web 103 for movement along a coating path through a plurality of web processing stations 105, 107, 109 and 111. In this exemplary process, web processing station 105 is a printing station wherein indicia is applied to one side of the web 103. The printing station 105 typically includes a dryer, or the web immediately thereafter traverses a drying station. The printed web is then advanced into the inventive coating station 107, wherein a striped pattern of coating fluid such as adhesive is applied to one surface of the web 103. This may be the surface that has already been printed on, or maybe the opposite surface of the web. After the coating pattern has been applied, the web is then advanced to a drying station 109 to dry or cure as necessary the coating which has just been applied. The web 103 is then further advanced to a further converting station 111, which may include additional printing stations, cutting or trimming stations, and the application of another layer of web material (i.e., an adhesive liner), or other further web converting processes to achieve a desired final product. FIG. 6 is merely exemplary of a possible web printing line which would include a coating-station 107 embodying the apparatus and method of the present invention. In various embodiments, printing on both sides of the web may occur prior to the coating station 107, or other converting operations may be applied to the moving web prior to the coating station 107. Likewise, further printing on one or both sides of the web, or further converting operations can take place down-web of the coating station 107. In addition, a second coating station which embodies the apparatus and method of the present invention can be provided to coat a secondary pattern of coating fluid on the same side of the web as already coated, or on the opposite side of the web.

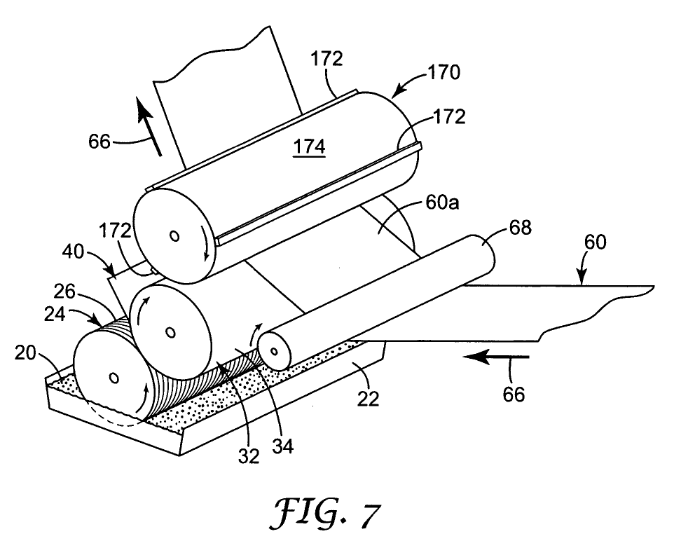

The inventive coating system and method described herein, when activated, applies a continuous pattern of stripes of coating fluid to a web (continuous along the length of the web, without interruption). In some instances, it may be desired to apply coating fluid intermittently along the length of the web. This can be accomplished by modifying the impression roll and controlling the distance between the impression roll and applicator roll, in the manner illustrated in FIGS. 7-10.

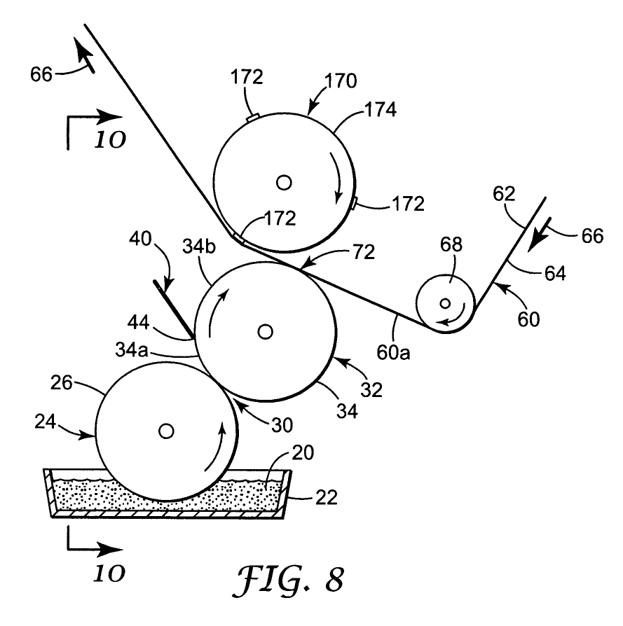

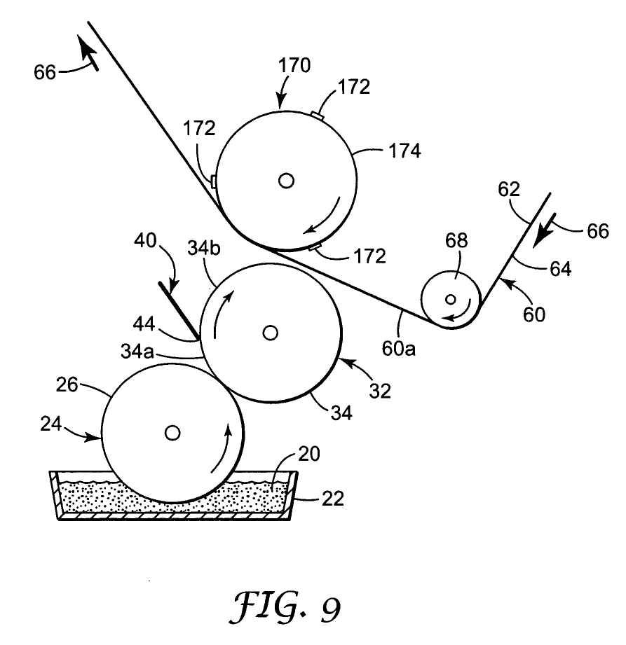

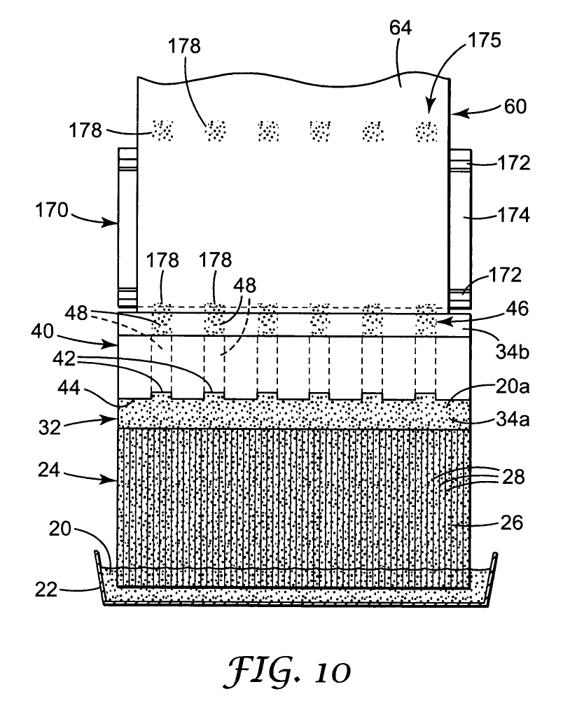

In the embodiments illustrated in FIGS. 1-5, the impression roll 70 has a generally smooth cylindrical outer surface. The components illustrated in FIGS. 7-10 are the same as illustrated in FIGS. 1-3, except for the configuration of the outer surface of the impression roll. In FIG. 7, rotating impression roll 170 has one or more raised image patterns or cams 172 extending longitudinally across its circumferential surface 174 (parallel to an axis of the impression roll 170). The raised image patterns 172 do not engage the applicator roll surface 34, but during rotation of the impression roll 170, serve to intermittently urge the coating surface 64 of the web 60 into coating fluid transfer contact with the applicator roll surface 34. FIG. 8 illustrates that the coating surface 64 of the web 60 contacts the applicator roll surface 34 when the free span 60a of the web 60 extends between the idler roll 68 and one of the raised image patterns 172 on the impression roll 170. FIG. 9 illustrates that the free span 60a of the web 60 does not contact the applicator roll surface 34 when it extends between the idler roll 68 and the circumferential surface 174 of the impression roll 170. Only when a raised image pattern 172 engages the top surface 62 of the web 60 and pushes it toward the applicator roll 32 (FIG. 8) does the free span 60a of the web 60 engage the post-doctor blade applicator roll surface 34b, as at line of contact 72. As explained above, the post-doctor blade applicator roll surface 34b bears the pattern 46 of coating fluid 20a (e.g., one or more stripes 48 of coating fluid). This pattern is only transferred to the web 60 when the free span 60a of the web 60 contacts the post-doctor blade applicator roll surface 34b (as caused by intermittently contact of the web 60 with the raised image patterns or cams 172 on the impression roll 170). Accordingly, the coating fluid pattern applied to the coating surface 64 of the web 60 is not continuous along the length of the web, but is intermittently applied as coating pattern 175 (see FIG. 10). Coating pattern 175 thus comprises intermittently applied short stripes of coating fluid 178 on the coating surface 64 of the web 60, as seen in FIG. 10. As can be appreciated, the raised image patterns or cams 172 can take on a variety of forms (e.g., stripes, circles, squares, etc.) to define the intermittent stripes 178 of coating fluid on the web 60. In addition the intermittent stripes 178 may be applied in registry with other images printed (or to be printed) on the web 60.

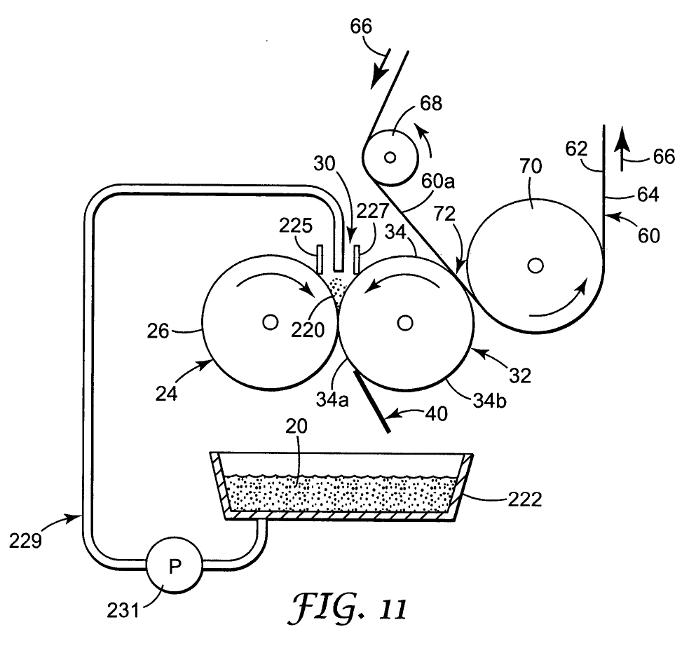

In an alternative embodiment of the inventive coating apparatus and method of the present invention, the coating fluid is introduced onto an applicator roll through a gate roll process, such as illustrated in FIG. 11. The alignment of the fountain roll 24 and applicator roll 32 is changed so that their axes are aligned essentially on the same horizontal plane (with the rolls 24 and 32 side by side), so that the nip 30 forms a fluid gate region for coating fluid 20 to collect above the rolls and then be metered through the nip 30. The coating fluid 20 thus forms a saddle 220 of coating fluid at the nip 30, where the rotating surfaces 26 and 34 of the fountain roll 24 and applicator roll 32 meet, respectively. If deemed necessary, the saddle 220 of coating fluid 20 can be further defined by side gate walls 225 and 227 (extending longitudinally along the surfaces of the fountain roll 24 and applicator roll 32, respectively), and end gate walls (not shown) extending between the roll surfaces. Coating fluid 20 is introduced into the nip 30 by a coating fluid recirculation system which includes a fluid collecting pan 222 below the fountain roll 24 and applicator roll 32and a coating fluid recycling and replenishment system 229 which (as discussed above with respect to the embodiment illustrated in FIG. 2) may include a pump 231 and other coating fluid control functions such as viscosity monitoring, viscosity control and coating fluid replenishment.

While the gate roll process of FIG. 11 for delivering coating fluid 20 to the surface 34 of the applicator roll 32 differs from the embodiments described above, the metering of the coating fluid through the gap 30 is otherwise the same to achieve a uniform deposition of coating fluid on the post-nip applicator roll surface 34a. The coating fluid on surface 34a then again encounters the doctor blade 40 which serves, through its notched edge configuration, to define the desired pattern of coating fluid stripes on the post-doctor blade applicator roll surface 34b. That pattern is carried by the applicator roll 32 until it is transferred to the web 60 at the line of contact 72 defined along free span 60a of the web 60. The stripes of coating fluid are transferred to the coating surface 64 of the web 60 in the manner described above, in a reverse kiss coating application. One advantage of the inventive coating apparatus and method illustrated FIG. 11 over the apparatus and method illustrated in FIGS. 1-5 is that because of the different manner in which the coating fluid is delivered to the nip 30 for metering and then recycled when doctored off the applicator roll 32, the coating fluid is less likely to foam. The coating fluid “pools” as a saddle of coating fluid 220 at the nip 30 as it is metered through the nip, rather then being carried up to the nip 30 by the fountain roll surface 26 from a supply of coating fluid in a lower pan.

The present invention is further illustrated by the following example, but the particular apparatus and processes recited in this example, as well as other conditions and details should not be construed to unduly limit this invention. All materials and components are commercially available or known to those skilled in the art unless otherwise stated or apparent. This example is illustrative in nature and is not intended to limit the invention in any way.

### EXAMPLE

In an arrangement generally like that illustrated in FIGS. 1-5, a 55 durometer cross-linked urethane rubber fountain roll was cut with a V-shaped helical groove of about 300 microns deep, at about 15 to about 60 degree tooth angle, and about 50 to about 200 lines per 5 inch. The groove was aligned at an angle of about 89.95 degrees relative to the axis of the fountain roll. The depth, tooth angle and the lines per inch were selected to relate to the size of the microsphere particle in the adhesive coating being applied and the desired uniformity of that coating on the substrate. The adhesive was picked up by the rubber fountain roll and metered by adjusting the nip pressure between the rubber fountain roll and a smooth chrome applicator roll. The nip pressure and the groove dimensions determined the desired adhesive coat weight. The film splitting action of the two rolls rotating at a 1:1 ratio and the rheology of the adhesive fluid established a fine line pattern of the adhesive fluid on the smooth chrome roll surface. A doctor blade with a notched template pattern was positioned near the nip between the rubber fountain roll and the smooth chrome roll. The unnotched portions of the doctor blade scraped the adhesive fluid off the smooth chrome roll surface in those areas where no adhesive was desired, thus leaving an adhesive pattern on the smooth chrome roll surface of a stripe (or stripes). The scraped and excessive adhesive flowed back onto the rubber fountain roll and was returned to an adhesive supply pan under the fountain roll. The stripes of adhesive fluid on the surface of the smooth chrome applicator roll were then wiped onto the substrate in a reverse kiss application. Typically, 100% of the adhesive was transferred to the substrate, and the adhesive stripe did not spread out, but approximated the original width of the notch defining the stripe in the doctor blade. By changing the speed of the surface of the smooth chrome roll in relation to the speed of the moving web, the smoothness and the coat weight of the applied adhesive on the web could be improved. In addition, by simply raising the web above the kiss point, the coating process could be turned on and off without requiring readjustment or cleaning.

Samples were made with a surface-active microsphere adhesive such as disclosed in U.S. Pat. No. 5,571,617, with 0.5% acrylic acid and 0.8% acryl amide at 37% solids. This formation on a solids basis was 90% microsphere adhesive and 10% Hycar 2600X22, an acrlyic latex at 50% solids available from Noveon, Inc., Cleveland, Ohio. A small amount of Surfynol DF-75 (available from Air products and Chemicals, Inc., Allentown, Pa.) was added to reduce foam. The viscosity of the adhesive fluid was 17.7 cps (using a Brookfield viscometer, spindle number 1, 60 RPM, available from Brookfield Engineering Laboratories, Inc., Middleboro, Mass.). The adhesive fluid was applied as a two inch wide stripe to a primed PET film using the coating assembly described above. The coating was applied to the web at 50 ft/min. The nip impression between the fountain roll and applicator roll, and the amount of overspeed ratio between the speed of the applicator roll and the web speed, were adjusted to affect the smoothness and adhesion level.

To establish the nip impression values, the fountain roll and applicator roll were urged together under pressure to a point where no fluid flow occurred through the nip between the rotating rolls. In this condition, the grooves in the rubber fountain roll were pressed down so far by pressure engagement with the smooth applicator roll that each groove (in cross section) was too small to permit a microsphere to pass through the nip between the fountain and applicator rolls. The nip pressure urging the rolls together was then reduced, thus allowing the rolls to back off from each other and this zero-fluid flow condition (although the rolls were still very much in contact because of the exerted nip pressure and deformation of the conformable rubber fountain roll), with the distance of such movement measured as the nip impression. By reducing the nip pressure, the grooves were opened up enough to allow the passage of microspheres through the nip.

Table 1 represents data obtained from 15 samples, with variations between samples of overspeed and nip impression.

TABLE 1

| | | Nip | | | |
|---|---|---|---|---|---|
| | | Impression | Adhesion to | Adhesive | Smooth- |
| | Overspeed | (thousandth | Bond | Transfer | ness |
| Sample | (percent) | of inch) | (grams/inch) | (percent) | Rating |
| 1 | 0 | 2.6 | 46.9 | 3 | 2.5 |
| 2 | 10 | 2.6 | 61.5 | 3.2 | 3 |
| 3 | 20 | 2.6 | 67.5 | 2.5 | 3.6 |
| 4 | 30 | 2.6 | 85.6 | 1.6 | 3.8 |
| 5 | 40 | 2.6 | 109.5 | 1.1 | 4 |
| 6 | 0 | 3 | 73.5 | 1.3 | 2 |
| 7 | 10 | 3 | 80.3 | 1.4 | 2.5 |
| 8 | 20 | 3 | 95.4 | 1.3 | 3 |
| 9 | 30 | 3 | 130.7 | 0.8 | 3.8 |
| 10 | 40 | 3 | 133.5 | 0.5 | 3.9 |
| 11 | 0 | 3.4 | 133.7 | 0.7 | 1.5 |
| 12 | 10 | 3.4 | 147.4 | 0.4 | 2 |
| 13 | 20 | 3.4 | 161.3 | 0.2 | 3 |
| 14 | 30 | 3.4 | 169.5 | 0.1 | 3.5 |
| 15 | 40 | 3.4 | 179.9 | 0 | 4 |

The “smoothness rating” is a subjective rating determined from visually inspecting the coated surface on the PET film. The scale of smoothness rating extended from zero (representing a poor smoothness) up to four (representing an excellent smoothness). A smoothness rating of three or above was deemed an acceptable product. The smoothness rating was found to be almost completely dependent upon the percent overspeed.

The “adhesion to bond” criteria was evaluated using the “peel adhesion” test method set forth in U.S. Pat. No. 5,571,617, except that bond paper (e.g., 20 lb/ream bond paper) was substituted for the polyester film. Peel adhesion is the force required to remove bond paper applied to the coated sample measured at a specific angle and rate of removal. In this example, this force is expressed in grams per 1.25 inches (3.2 cm) width of coated sample. The procedure followed was:

A strip, 1.25 inches (3.2 cm) wide, of bond paper was applied to the horizontal surface of a coated sample fixed on a test plate. A 4.5 pound (2 kg) hard rubber roller was used to apply the strip. The free end of the bond paper was attached to the adhesion tester load cell so that the angle of removal would be 90 degrees. The test plate was then clamped in the jaws of a tensile testing machine that was capable of moving the plate away from the load cell at a constant rate of 12 inches (31 cm) per minute. A load cell reading in grams per 1.25 inches (3.2 cm) of coated stripe was recorded as the bond paper was peeled from the coated samples. Each sample was tested three times. The average of the three tests is reported in Table 1.

It was determined that the adhesion to bond paper is mainly dependent on the nip impression, but is affected by the percent overspeed as well. The adhesion level of the repositionable adhesive and the smoothness level could be easily adjusted to a desired level by adjusting the control factors (e.g., percent overspeed and nip impression) in the coating process. In addition, these adjustments could be accomplished without adhesive coagulation.

Although the present invention has been described with reference to preferred embodiments, workers skilled in the art will recognize that changes may be made in form and detail without departing from the spirit and scope of the invention. All publications and patents are incorporated herein by reference to the same extent as if each individual publication or patent was specifically and individually indicated to be incorporated by reference. Also incorporated herein by reference is co-assigned U.S. patent application Ser. No. ______, filed on even date herewith, on “Method for Defining a Coating Fluid Pattern” (attorney docket No. 60437US002).

1. A method of defining a pattern of coating fluid on a surface comprises:
introducing coating fluid into a nip defined between a surface of a first roll and a surface of a second roll, wherein the first roll surface and the second roll surface are urged together at the nip under a nip pressure, wherein the roll surfaces move in opposite directions towards the coating fluid in the nip, and wherein the amount of coating fluid metered onto the second roll surface after the nip is a function of the topography of the first roll surface and the nip pressure; and
engaging selected portions of the second roll surface with a doctor blade to remove coating fluid therefrom, wherein a pattern of coating fluid remains on the second roll surface which is defined by at least one stripe of coating fluid.

2. The method of claim 1, and further comprising:
transferring the pattern of coating fluid from the second roll surface onto a coating surface of a moving web.

3. The method of claim 1 wherein the topography of the first roll surface comprises a helical groove formed therein.

4. The method of claim 1 wherein the introducing step comprises:
applying the coating fluid onto the first roll surface, which is defined as the surface of a rotating fountain roll;
and transferring the coating fluid from the surface of the fountain roll onto the second roll surface, which is defined as the surface of a rotating applicator roll.

5. The method of claim 1 wherein the introducing step comprises:
aligning the first roll and the second roll generally side-by-side and engaging to define the nip between the respective surfaces thereof; and
depositing coating fluid onto a fluid gate region defined by the first and second roll surfaces above the nip.

6. The method of claim 3 wherein the helical groove is aligned at an angle of about 80 degrees to about 90 degrees relative to an axis of the first roll surface.

7. The method of claim 3 wherein the coating fluid comprises adhesive microspheres of a selected size, and wherein the helical groove is sized under the nip pressure to at least partially accept the microspheres therein.

8. The method of claim 7 wherein the selected size for the adhesive microspheres is from about 5 to about 200 microns in diameter.

9. The method of claim 3 wherein the helical groove has a depth of about 50 to about 300 microns, and is disposed at about 40 to about 300 grooves per inch laterally across the first roll surface.

10. The method of claim 3 wherein the helical groove is a V-shaped groove having a tooth angle of about 15 to about 120 degrees.

11. The method of claim 2, and further comprising:
selectively engaging the coating surface of the moving web with the second roll surface bearing the pattern of coating fluid.

12. The method of claim 11, wherein the selectively engaging step comprises:
moving an impression roll over which the moving web traverses toward the second roll until the coating surface of the moving web contacts the second roll surface bearing the pattern of coating fluid.

13. The method of claim 12, wherein the impression roll has a raised image pattern extending longitudinally across a circumferential surface thereof, and further comprising:
as the impression roll is rotated and the moving web passes thereby, selectively engaging the rear surface of the moving web with the raised image pattern to urge the coating surface of the moving web into intermittent engagement with the pattern of coating fluid on the second roll, thereby intermittently transferring coating fluid from the second roll surface to the moving web.

14. The method of claim 1 wherein the pattern of coating fluid remaining on the second roll surface comprises a first plurality of stripes of coating fluid.

15. The method of claim 14, and further comprising:
modifying the pattern of coating fluid remaining on the second roll by changing an edge formation of the doctor blade to define a second, differently aligned plurality of stripes of coating fluid on the second roll surface.

16. The method of claim 1 wherein the first roll surface is conformable.

17. The method of claim 1 wherein the second roll surface is smooth and non-conformable.

18. The method of claim 1 wherein the coating fluid, as metered onto the second roll surface, covers the second roll surface as a uniform and continuous layer.

19. The method of claim 1, and further comprising:
advancing the moving web past a drying station to fix the pattern of coating fluid thereon.

20. The method of claim 1, and further comprising:
advancing the moving web past a printing station for printing indicia on one or more of the surfaces of the moving web.

21. The method of claim 2, and further comprising:
moving the second roll surface at a first speed; and
advancing the moving web past the second roll surface at a second speed which is slower than the first speed.

22. The method of claim 2 wherein the moving web engages the second roll surface in a reverse kiss orientation.

23. The method of claim 1 wherein the two roll surfaces move at about the same speed.

24. The method of claim 1 wherein the first roll surface moves at a slower speed than the second roll surface.

25. A method of applying a coating fluid onto a moving web having a coating surface and an opposed rear surface, wherein the method comprises:
applying coating fluid onto a rotating fountain roll surface;
transferring the coating fluid from the fountain roll surface onto a rotating applicator roll surface, wherein the amount of coating fluid transferred is a function of the topography of the fountain roll surface and a nip pressure between the two surfaces;
engaging selected portions of the applicator roll surface with a doctor blade to remove coating fluid therefrom, wherein a pattern of coating fluid remains on the applicator roll surface which is defined by at least one stripe of coating fluid; and
transferring the stripe of coating fluid from the applicator roll surface onto the coating surface of the moving web.

26. The method of 25 wherein the topography of the fountain roll surface comprises a helical groove formed thereon.

27. The method of claim 25 wherein the fountain roll is rotated in a first rotational direction, the applicator roll is rotated in a second, opposite rotation direction, and the web is moved past the applicator roll in a reverse kiss orientation.

28. The method of claim 27, and further comprising:
moving the surfaces of the fountain roll and applicator roll at about the same speed relative to one another.

29. The method of claim 27, and further comprising:
moving the surface of the fountain roll at a slower speed than the surface of the applicator roll.

30. The method of claim 25 wherein the fountain roll surface is conformable, and further comprising:
urging the surfaces of the fountain roll and the applicator rolls together.

31. An apparatus for defining a striped pattern of coating fluid comprising microspheres on a roll comprises:
a first conformable rotating roll;
a second non-conformable rotating roll aligned with the first roll to define a coating fluid metering nip therebetween, wherein the first and second rolls are urged together at the nip, and wherein the first roll has a surface topography comprising surface features deep enough to permit passage of one or more coating fluid microspheres therein through the nip; and
a doctor blade engaged with a post-nip surface of the second roll bearing coating fluid, the doctor blade shaped to removed coating fluid from only selected portions of second roll surface, wherein a pattern of coating fluid remains on the second roll surface which is defined by at least one stripe of coating fluid.
